(19) United States
(12) Patent Application Publication
(10) Pub. No.: US 2022/0056996 A1
(43) Pub. Date: Feb. 24, 2022

(54) APPARATUS AND METHOD FOR SERVICING A STUFFING BOX

(71) Applicant: Jayson King, Corning (CA)

(72) Inventor: Jayson King, Corning (CA)

(21) Appl. No.: 16/998,520

(22) Filed: Aug. 20, 2020

(51) Int. Cl. F16J 15/18; E21B 33/03

(52) U.S. Cl. CPC F16J 15/18; E21B 43/126; E21B 33/03

(57) ABSTRACT

A maintenance tool apparatus for servicing a stuffing box for a wellhead having an upright arm coupled to a portion of the wellhead at one end and an elongate arm coupled to another end of the upright arm. The elongate arm having a resting end configured to rest on a polish rod of the wellhead. Also, a method for servicing a stuffing box for a wellhead has the steps of: placing a resting end of a maintenance apparatus against a polish rod; uncoupling at least one of a packing gland and a dust cover from a stuffing box; sliding the packing gland and the dust cover along the polish rod above the resting end of the maintenance apparatus; maintaining the position of the packing gland and the dust cover; and repacking the stuffing box.

### TECHNICAL FIELD

This invention is in the field of servicing stuffing boxes on a wellhead that is used for pumping oil out of the ground. More specifically, the invention relates to a tool for assisting with the servicing of a stuffing box.

### BACKGROUND

Oil wells are used to remove oil from subterranean reservoirs. Typically, the oil is removed from the well using artificial lift techniques which cause the oil to be pumped up the well to the ground surface. A common artificial lift technique is the use of a downhole pump that has a device at the bottom of the well that is used to pump the oil up the well to the ground surface. The device at the bottom of the well is driven by a string of sucker rods that extend from the ground surface down to the pumping device. By reciprocating the string of sucker rods up and down in the well, the pumping device is driven causing oil to be pumped up the well. The sucker rods are reciprocated at the ground surface typically with a pump jack or other device.

When a pump jack is used to cause the reciprocating of the sucker rods, a head of the pump jack is typically connected by a bridle to a polish rod that passed into the wellhead. The well head caps the top of the well and the polish rod is inserted into the wellhead through a stuffing box that is connected to the top of the wellhead. The stuffing box is meant to prevent liquid from the well leaking out where the polish rod enters into the well. The stuffing box contains packing (or stuffing) inside which presses against the polish rod as the rod moves up and down in the stuffing box. The stuffing forms a seal and prevents oil and other liquid from escaping along the polish rod and out of the wellhead. The polish rod has a smooth (e.g. polished) surface meant to form a better seal with the packing in the stuffing box.

The stuffing box, however, is not infallible and it is possible for it to leak. In some cases if liquid stops being pumped up the well for a period of time, such as if the pump jack is stopped or liquid stops flowing from downhole, the packing in the stuffing box can dry out and when the pumping of oil or other liquid up the well begins again, some of this liquid may leak out past the dried packing. If the pump jack continues to reciprocate while the packing has dried out, the packing might become damaged by the movement of the polish rod. Sometimes the packing might just wear out over time and it is not until the oil is detected leaking out of the stuffing box that it is detected. Periodic maintenance of the stuffing box is therefore necessary to ensure proper operation and prevention of leaks.

### SUMMARY

The present application is directed to the aspects as described herein in any and/or all combinations as understood by a person of skill in the art on review of the specification and drawings herein.

### BRIEF DESCRIPTION OF THE DRAWINGS

While the invention is claimed in the concluding portions hereof, example embodiments are provided in the accompanying detailed description which may be best understood in conjunction with the accompanying diagrams where like parts in each of the several diagrams are labeled with like numbers, and where:

FIG. 1 is a side cross-sectional view of a hanger arm for a stuffing box with a containment device in an operating position;

FIG. 2 is a side cross-sectional view of the hanger arm for the stuffing box with the containment device in a maintenance position;

FIGS. 3a-3c are side cross-sectional views of the hanger arm for the stuffing box in three different configurations; and

FIG. 4 is a side view photograph of the hanger arm for the stuffing box in the maintenance position.

### DETAILED DESCRIPTION

In order to repack the stuffing box 102, previous methods involved unbolting the stuffing box dust cap 106 (e.g. dust collar) and pushing the dust cap 106 and/or packing gland 108 up the polish rod 104 and holding the dust cap 106 and/or packing gland 108 in place with a set of vice grips (not shown) on the polish rod 104. The use of the vice grips can scar the polish rod 104, which effects a pumping motion and can cause faster breakdown of the polish rod 104. The scarring may also cause faster wear of the packing if the polish rod 104 is not an absolute straight stroke through the stuffing box 102. As described herein, a maintenance apparatus 200 may at least: eliminate the use of vice grips and consequently the scarring of the polish rod 104, provide a safer hold and lift of the upper gland 108 of the stuffing box 102, has one or more hooks 214 to keep required tools close at hand and off of the ground, and may be portable permitting transporting the maintenance apparatus 200 to other wells once the packing change is completed.

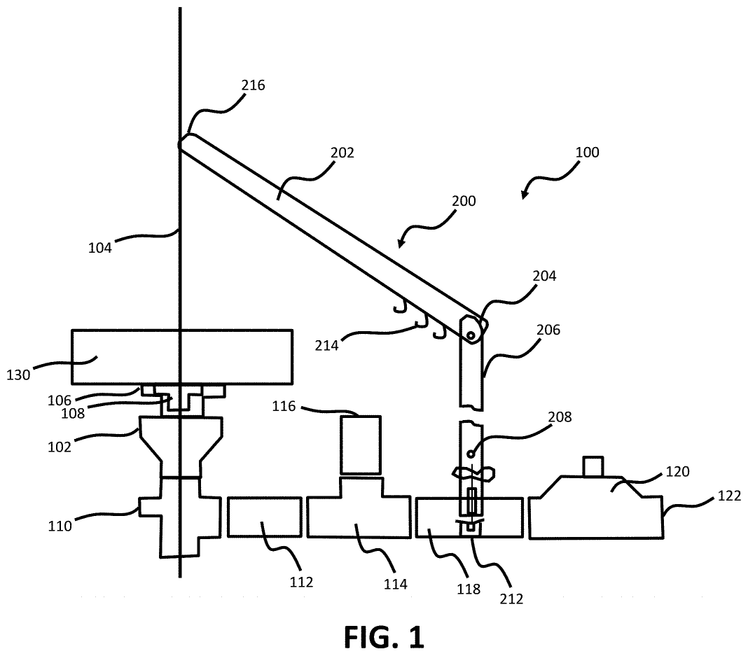

FIGS. 1, 2, and 4 illustrates an example of wellhead 100 having a stuffing box 102 where a polish rod 104 may reciprocate in and out of a top of the stuffing box 102 through a dust cap 106. A base of the stuffing box 102 may be connected to a pumping tee 110 that may draw oil and other liquids through an upper blowout preventer 112 coupled to a pressure control tee 114. The pressure control tee 114 may be connected to an automatic pressure control (presco) 116 and a pipe 118. The pipe 118 may be connected to a tee valve 120 for turning on and off the flow from the main wellhead 122.

Tightening bolts (not shown) may be provided around the stuffing box 102 such that periodically tightening these bolts may compress the stuffing box 102 and may place pressure on packing (not shown) in the stuffing box 102. The pressure may force the packing against the polish rod 104 during reciprocation in and out of the stuffing box 102. By slowly tightening the tightening bolts over time, the packing may be caused to continue to form a seal against the polish rod 104 as the packing wears. Packing in the stuffing box 102 may form a seal with an outer surface of the polish rod 104 to prevent oil or other liquid from leaking out of the stuffing box 102.

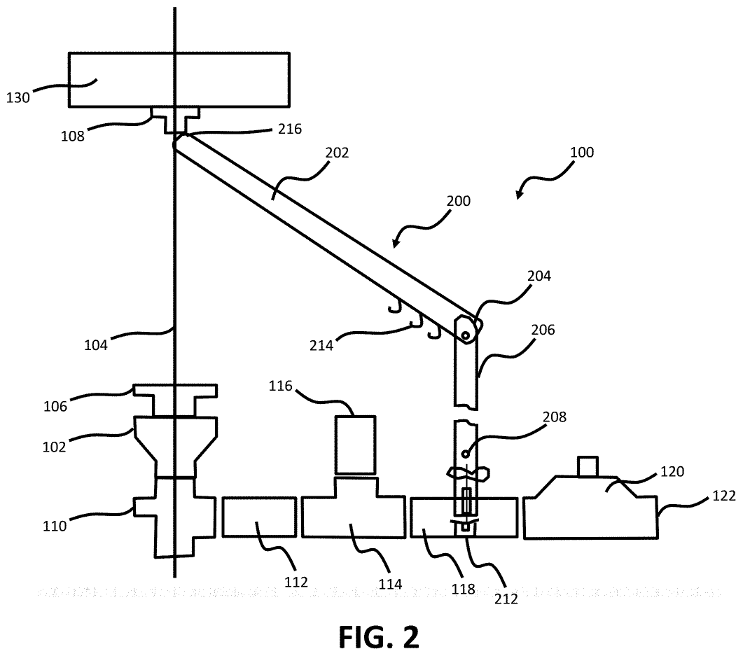

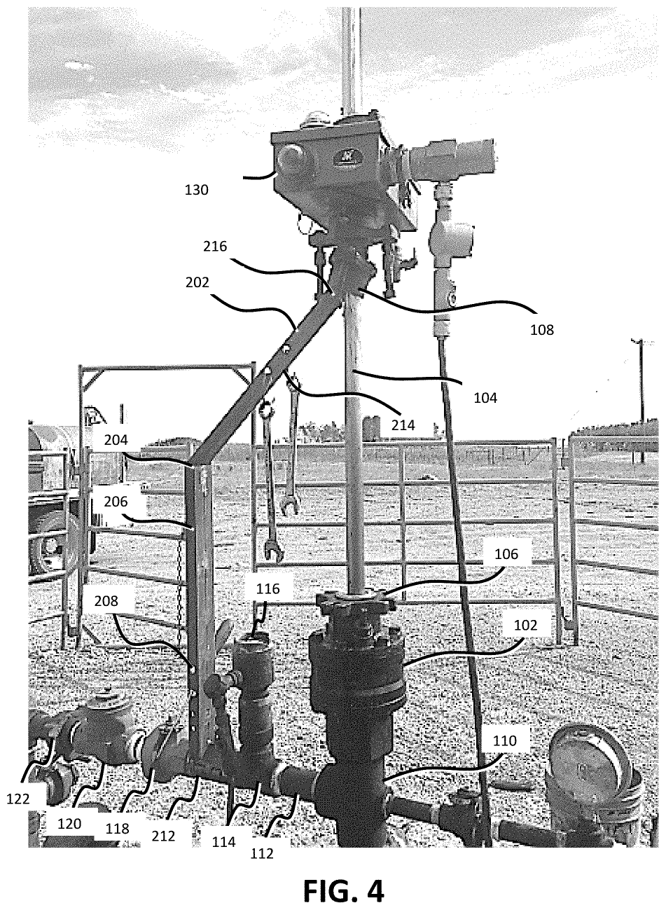

In some aspects, a containment device 130 may be installed on the polish rod 104 above the stuffing box 102. As shown in FIG. 1, the containment device 130 may be in an operating position as shown in FIG. 1 or in a maintenance position as shown in FIGS. 2 and 4. The polish rod 104 may pass completely through the containment device 130 and may permit the polish rod 104 to reciprocate through the containment device 130. When in the operating position, the containment device 130 may collect any oil leaking out of the stuffing box 102, and in particular, may collect any oil leaking around where the polish rod 104 enters the stuffing box 102.

When in the operating position, a packing gland 108 may be received by the dust collar 106 such that any oil or other liquid that may leak out of the top of the stuffing box 102 may be scraped off the polish rod 104 by the packing gland 108.

As shown in FIG. 1, a maintenance apparatus 200 may be removably coupled to at least a portion of the wellhead 100 using one or more fasteners 212. The maintenance apparatus 200 may comprise a generally elongate hanger arm 202 that may rest against the polish rod 104 at one end and be rotatably coupled by a pivot 204 to an upright arm 206 at the other end. In this aspect, when viewed from an end 216, the hanger arm 202 may comprise an inverted U-shape in order to encompass a portion of the polish rod 104 to facilitate in holding the hanger arm 202 in alignment with the polish rod 104. In some aspects, a contact surface of the resting end 216 of the hanger arm 202 that rests on the polish rod 104 may be smooth, padded, and/or non-abrasive in order to reduce a likelihood of damage to the polish rod 104. The resting end may also be machined generally into a crescent in order to rest against the polish rod 104.

In FIGS. 1 and 2, the upright arm 206 has been shortened to enable efficient depiction of the maintenance apparatus 200. The upright arm 206 may be a similar length to or longer than the hanger arm 202. The upright arm 206 may have one or more retainers 208, such as holes or apertures, for receiving one or more tools, such as screwdrivers, used to change out the packing. The hanger arm 202 may have one or more retainers 214, such as hooks, clips, or brackets, for receiving one or more tools, such as wrenches, used for changing out the packing. The retainers 208, 214 may hold the tools out of the way and off the ground but accessible to the maintenance crew.

At a base of the upright arm 206 may be a fastener 212 for fastening the upright arm 206 to the wellhead 100. In this aspect, the upright arm 206 may be fastened to piping before the tee valve 120 that ties the stuffing box into the wellhead 100. In this aspect, the fastener 212 may be a wingnut and clamp. When the maintenance apparatus 200 is installed on the wellhead 100, the upright arm 206 may be in a generally vertical orientation with respect to the ground and the hanger arm 202 may rest against the polish rod 104 at a generally 45-degree angle.

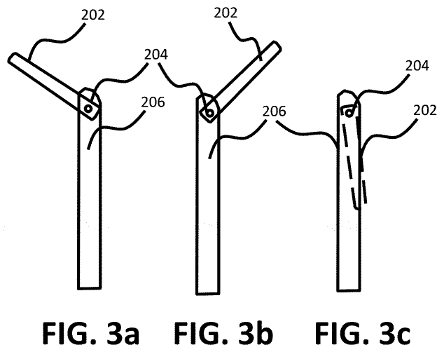

In another aspect shown in FIGS. 3a to 3c, when not in use, the hanger arm 202 may be rotated away from the polish rod 104 to be placed into a storage position shown in FIG. 3c where the hanger arm 202 generally aligns with the upright arm 206.

When maintenance of the stuffing box 102 is required, an operator or maintenance crew may release the packing gland 108 and/or the dust cover 106 on the stuffing box 102 by unscrewing one or more upper bolts on the stuffing box 102. The packing gland 108, the dust cover 106, and/or the containment device 130 (if one is present) may then be slid upward along the polish rod 104 and past the hanger arm 202. The hanger arm 202 may rotate on the pivot 204 away from the polish rod 104 permitting the packing gland 108, the dust cover 106, and/or the containment device 130 to pass by the hanger arm 202. Once the packing gland 108, the dust cover 106, and/or the containment device 130 are past the hanger arm 202, the hanger arm 202 rotates back towards the polish rod 104. The hanger arm 202 may then retain the packing gland 108, the dust cover 106, and/or the containment device 130 in a maintenance position (as shown in FIG. 2) above the hanger arm 202 and out of the way so that the packing may be changed in the stuffing box 102.

Although the aspects described herein demonstrate the pivot 204 between the hanger arm 202 and the upright arm 206, other aspects may have a fixed joint between the two arms 202, 206. In this aspect, the hanger arm 202 may be sufficiently flexible to allow the packing gland 108, the dust cover 106, and/or the containment device 130 to pass by when moving from the operating position to the maintenance position. Once the required maintenance on the stuffing box 102 is completed, the crew may bend the hanger arm 202 away from the polish rod 104 permitting the packing gland 108, the dust cover 106, and/or the containment device 130 to slide down the polish rod 104.

Although the aspects described herein demonstrate a removable maintenance apparatus 200, other aspects may have the maintenance apparatus 200 integrally formed with one of the components of the wellhead 100.

The maintenance tool and/or method described herein may apply to other types of servicing where one or more components may be slid on a shaft in a generally vertical direction and maintained at that position until servicing is complete.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

What is claimed is:

1. A maintenance apparatus for servicing a stuffing box for a wellhead comprising:
an upright arm coupled to a portion of the wellhead at one end;
an elongate arm coupled to another end of the upright arm; and
the elongate arm comprising a resting end configured to rest on a polish rod of the wellhead.

2. The maintenance apparatus according to claim 1, wherein the elongate arm is rotatably coupled to the upright arm.

3. The maintenance apparatus according to claim 2, further comprising a pivot between the upright arm and the elongate arm.

4. The maintenance apparatus according to claim 1, wherein the elongate arm is flexibly coupled to the upright arm.

5. The maintenance apparatus according to claim 1, wherein the resting end comprises an inverted U-shape encompassing a portion of the polish rod.

6. The maintenance apparatus according to claim 1, wherein the resting end comprises a crescent for resting against the polish rod.

7. The maintenance apparatus according to claim 1, wherein a contact surface of the resting end is at least one of: smooth, padded, and non-abrasive.

8. The maintenance apparatus according to claim 1, wherein the upright arm is removably coupled to the portion of the wellhead using a fastener.

9. The maintenance apparatus according to claim 1, wherein the upright arm is vertical with respect to a ground and the elongate arm rests against the polish rod at a 45-degree angle.

10. The maintenance apparatus according to claim 1, further comprising at least one retainer for receiving at least one tool.

11. The maintenance apparatus according to claim 10, wherein the upright arm comprises the at least one retainer.

12. The maintenance apparatus according to claim 10, wherein the elongate arm comprises the at least one retainer.

13. The maintenance apparatus according to claim 10, wherein the at least one retainer is selected from at least one of: a hook, a clip, a bracket, and an aperture.

14. A method for servicing a stuffing box for a wellhead comprises:
placing a resting end of a maintenance apparatus against a polish rod;
uncoupling at least one of a packing gland and a dust cover from a stuffing box;
sliding the packing gland and the dust cover along the polish rod above the resting end of the maintenance apparatus;
maintaining the position of the packing gland and the dust cover; and
repacking the stuffing box.

15. The method according to claim 14, further comprises:
releasing the resting end from the polish rod;
sliding the packing gland and the dust cover down the polish rod; and
coupling the packing gland and the dust cover to the stuffing box.

16. The method according to claim 14, further comprises:
coupling an end of an upright arm of the maintenance apparatus to a portion of the wellhead.

17. The method according to claim 16, further comprises:
rotating an elongate arm around another end of the upright arm in order to place the resting end against the polish rod.

18. The method according to claim 16, further comprises:
flexing an elongate arm around another end of the upright arm in order to place the resting end against the polish rod.

19. The method according to claim 16, further comprises:
releasing the end of the upright arm from the portion of the wellhead.

20. The method according to claim 14, further comprises:
placing at least one tool within at least one retainer of the maintenance apparatus.
